(19) United States
(12) Patent Application Publication
(10) Pub. No.: US 2024/0302250 A1
(43) Pub. Date: Sep. 12, 2024

(54) LIQUID SAMPLING METHOD IN FLOW MONITORING SYSTEM

(71) Applicants: SHIMADZU CORPORATION, Kyoto (JP); DIRECTOR GENERAL OF NATIONAL INSTITUTE OF HEALTH SCIENCES, Kanagawa (JP)

(72) Inventors: Takuya YOSHIOKA, Kyoto (JP); Yosuke IWATA, Kyoto (JP); Yusuke NAGAI, Kyoto (JP); Katsumasa SAKAMOTO, Kyoto (JP); Takuji SHODA, Kanagawa (JP); Tomoaki SAKAMOTO, Kanagawa (JP)

(73) Assignees: SHIMADZU CORPORATION, Kyoto (JP); DIRECTOR GENERAL OF NATIONAL INSTITUTE OF HEALTH SCIENCES, Kanagawa (JP)

(21) Appl. No.: 18/594,095

(22) Filed: Mar. 4, 2024

(30) Foreign Application Priority Data
Mar. 6, 2023 (JP) 2023-033409

(51) Int. Cl. G01N 1/20; G01N 1/14; G01N 1/40

(52) U.S. Cl. CPC G01N 1/20; G01N 1/14; G01N 1/40

(57) ABSTRACT

A liquid sampling method in a flow monitoring system including a sampling section having a needle for performing sampling of a liquid, an analysis section that performs analysis of the liquid sampled by the sampling section, and a fluid supply section that supplies a sample fluid in a state of gas-liquid two-phase flow containing a gas phase and a liquid phase with the sample remaining in the state of gas-liquid two-phase flow. The liquid sampling method includes: a storage step of storing, in the storage container, a liquid phase contained in the sample fluid; a separation step of separating, from a liquid phase, a gas phase contained in the liquid phase stored in the storage container; and an injection step of suctioning, as a sample, the liquid phase stored in the storage container from a distal end of the needle after the separation step and injecting a predetermined amount of the sample into the analysis section through the injection port.

### BACKGROUND OF THE INVENTION

### 1. Field of the Invention

The present invention relates to a liquid sampling method in a flow monitoring system.

### 2. Description of the Related Art

A chromatograph is often used for monitoring of reaction treatment. In that case, the fluid during the reaction treatment is supplied to a flow vial, and the fluid flowing inside the flow vial is collected by a needle, injected into an analysis flow path of the chromatograph, and analyzed by the chromatograph (see WO 2019/038928).

In flow synthesis, which is one field of organic synthesis, a reaction may be performed in a gas-liquid system in which a gas such as hydrogen and a liquid such as an aromatic hydrocarbon are mixed with a synthetic material, and in this case, the gas of the material may remain without reacting (see Polysilane-Immobilized Rh—Pt Bimetallic Nanoparticles as Powerful Arene Hydrogenation Catalysts: Synthesis, Reactions under Batch and Flow Conditions and Reaction Mechanism). A gas may be contained as a reaction product. In such a case, a sample containing a reaction product becomes a gas-liquid two-phase flow containing a gas phase and a liquid phase. When monitoring of such reaction product is performed, it is difficult to accurately sample a desired amount of liquid phase from the gas-liquid two-phase flow flowing through a flow vial with a needle in a chromatograph designed on the premise of handling a liquid. Therefore, a gas-liquid separation mechanism for separating the gas phase and the liquid phase is installed upstream of the flow vial, and only the liquid phase is introduced into the flow vial, whereby a desired amount of the liquid phase can be accurately sampled.

### SUMMARY OF THE INVENTION

While various gas-liquid separation mechanisms exist, any of the mechanisms has problems that an internal capacity is large, a delay time until the sample reaches the flow vial occurs, which makes it difficult to perform accurate monitoring, carryover easily occurs because a reaction product tends to remain in the mechanism, and the flow rate does not become constant due to intermittent discharge.

The present invention has been made in view of the above problems, and an object thereof is to enable accurate sampling of a desired amount of liquid phase from a fluid in a state of gas-liquid two-phase flow without using a gas-liquid separation mechanism.

A liquid sampling method according to the present invention is a liquid sampling method in a flow monitoring system, wherein the flow monitoring system includes a sampling section having a needle for performing sampling of a liquid and a storage container, an analysis section that performs analysis of the liquid sampled by the sampling section, and a fluid supply section that supplies a sample fluid in a state of gas-liquid two-phase flow containing a gas phase and a liquid phase with the sample remaining in the state of gas-liquid two-phase flow, the liquid sampling method including:
a storage step of collecting a predetermined amount of the sample fluid flowing through the liquid supply section and storing the collected sample fluid in the storage container;
a separation step of separating a gas phase contained in the sample fluid stored in the storage container from a liquid phase; and
an injection step of suctioning the liquid phase stored in the storage container from a distal end of the needle after the separation step and injecting a predetermined amount of the liquid phase as a sample into the analysis section through the injection port.

The liquid sampling method according to the present invention enables sampling, as a sample, a predetermined amount of a liquid phase without providing a flow monitoring system with a gas-liquid separation mechanism by, in sampling, after storing the sample fluid supplied from the fluid supply section in the storage container and separating a gas phase contained in the sample fluid from a liquid phase in the storage container, suctioning, with the needle, the liquid phase stored in the storage container as a sample, and injecting a predetermined amount of the sample into the analysis section.

### BRIEF DESCRIPTION OF THE DRAWINGS

FIG. 1 is a schematic configuration diagram showing an example of a flow monitoring system that executes a liquid sampling method;

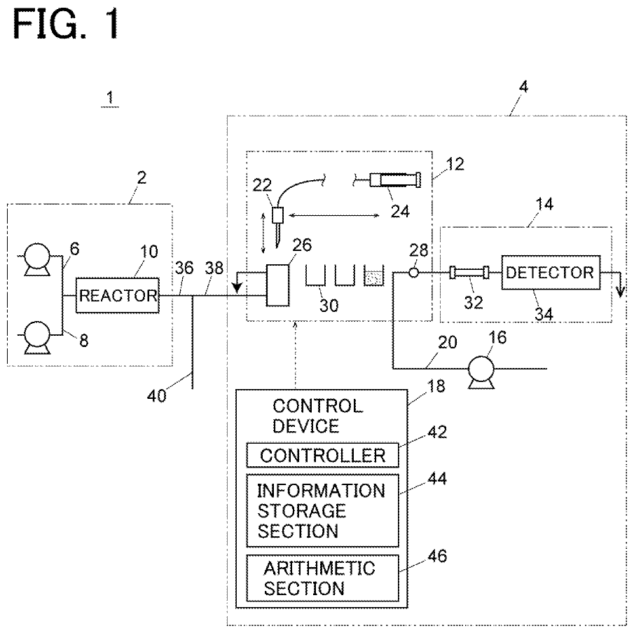

FIG. 2 is a flowchart showing an example of a liquid sampling method; and

FIG. 3 is a schematic configuration diagram for explaining another example of a flow monitoring system that executes a liquid sampling method.

### DETAILED DESCRIPTION OF THE INVENTION

Hereinafter, an example of a liquid sampling method according to the present invention will be described with reference to the drawings.

A flow monitoring system 1 that executes the liquid sampling method mainly includes a flow synthesis device 2 and an analysis device 4. The flow synthesis device 2 constitutes a fluid supply section that supplies the analysis device 4 with a sample fluid in a state of gas-liquid two-phase flow containing a gas phase and a liquid phase.

The flow synthesis device 2 is a device that supplies two types of fluids to a reactor 10 by two pumps 6 and 8, and reacts the two types of fluids in the reactor 10 to obtain a reaction product. One of the two types of fluids supplied to the reactor 10 by the pumps 6 and 8 is a liquid and the other is a gas. The reaction product obtained in the reactor 10 flows through an outlet flow path 36 of the reactor 10 in a state of gas-liquid two-phase flow. The outlet flow path 36 is branched into flow paths 38 and 40, and a part of the reaction product flowing out of the reactor 10 is supplied as a sample fluid to a flow vial 26 described later through the flow path 38 in a state of gas-liquid two-phase flow.

The analysis device 4 includes a sampling section 12, an analysis section 14, a liquid feeding pump 16, and a control device 18. The sampling section 12 injects, into the analysis section 14, a liquid phase in a sample fluid supplied from the flow synthesis device 2. The analysis section 14 performs analysis of the sample injected by the sampling section 12. The control device 18 performs operation management of the analysis device 4. The liquid feeding pump 16 feeds a mobile phase toward the analysis section 14 through an analysis flow path 20.

The sampling section 12 includes a needle 22, a syringe pump 24, the flow vial 26, an injection port 28, and a storage container 30.

The needle 22 is for performing suctioning and dispensing of a fluid from a distal end. The needle 22 moves three-dimensionally in a state where the distal end faces vertically downward, and can access the flow vial 26, the injection port 28, and the storage container 30.

The syringe pump 24 is provided so as to be fluidly connected to the needle 22, and can perform suctioning and discharging of a fluid through the needle 22.

The flow vial 26 is provided so that the needle 22 can access an internal space from above. A side surface of the flow vial 26 is provided with an inlet for causing a sample fluid to flow into an internal space and an outlet for causing the sample fluid to flow out from the internal space, and the sample fluid supplied through the flow path 38 constantly flows in the internal space of the flow vial 26 in a state of gas-liquid two-phase flow.

The injection port 28 is for injecting a sample from the needle 22 into the analysis section 14. The injection port 28 is configured to receive the distal end of the needle 22 to enable fluid connection of the needle 22. The sample injected from the needle 22 through the injection port 28 is guided to the analysis section 14 together with the mobile phase flowing through the analysis flow path 20.

The storage container 30 is a container of an open top surface in which the needle 22 can access from above. In this example, a plurality of the storage containers 30 are provided.

The analysis section 14 includes a separation column 32 and a detector 34. The separation column 32 is provided on the analysis flow path 20 and is for separating components in the sample injected into the mobile phase through the injection port 28 by the sampling section 12 from each other. The detector 34 is provided downstream of the separation column 32 on the analysis flow path 20, and is for detecting each component separated by the separation column 32.

The control device 18 is implemented by a computer device including a central processing section (CPU) and an information storage device, such as a personal computer. The control device 18 includes a controller 42, an information storage section 44, and an arithmetic section 46. The controller 42 and the arithmetic section 46 are functions implemented by the CPU executing software. The information storage section 44 is a function implemented by a part of storage area of the information storage device.

The controller 42 is configured to control the operation of the sampling section 12 to execute sampling of the sample fluid supplied from the flow synthesis device 2 to the flow vial 26. In sampling, a storage step of storing, into the storage container 30, a liquid phase in a sample fluid by performing, one time or more, a storage operation of collecting and dispensing, into the storage container 30, the sample fluid from the flow vial 26, and an injection step of injecting, into the analysis section 14 through the injection port 28, as a sample, a liquid layer stored in the storage container 30 in the storage step are executed. A specific operation of the sampling will be described later.

The information storage section 44 stores information necessary for execution of the sampling. The information necessary for execution of the sampling includes an internal capacity of the syringe pump 24 (the maximum volume of the fluid that can be suctioned at one time), a gas-liquid mixing rate that is the volume percent between the gas phase and the liquid phase contained in the sample fluid supplied from the flow synthesis device 2, and an injection amount of the sample into the analysis section 14. These pieces of information can be input in advance by the user.

The arithmetic section 46 is configured to calculate the times of storage operation to be executed in the storage step described above using the information stored in the information storage section 44. When the gas-liquid mixing rate, which is the ratio of the gas phase and the liquid phase contained in the sample fluid supplied from the flow synthesis device 2, is large (the ratio of the gas phase is high), it is considered that a liquid phase of an amount to be injected into the analysis section 14 as a sample cannot be stored in the storage container 30 by one time of storage operation depending on the internal capacity of the syringe pump 24. Therefore, from the relationship among the gas-liquid mixing rate of the sample fluid supplied from the flow synthesis device 2, the internal capacity of the syringe pump 24, and the injection amount of the sample into the analysis section 14, the arithmetic section 46 calculates the times of storage operation necessary for storing, into the storage container 30, a liquid phase equal to or greater than the injection amount of the sample into the analysis section 14. The controller 42 executes, during the storage step, the storage operation the flow path calculated by the arithmetic section 46.

Note that the arithmetic section 46 is not an essential function. The times of storage operation to be executed in the storage step may be configured to be preset by the user. In that case, the controller 42 executes, during the storage step, the storage operation the flow path set in advance by the user.

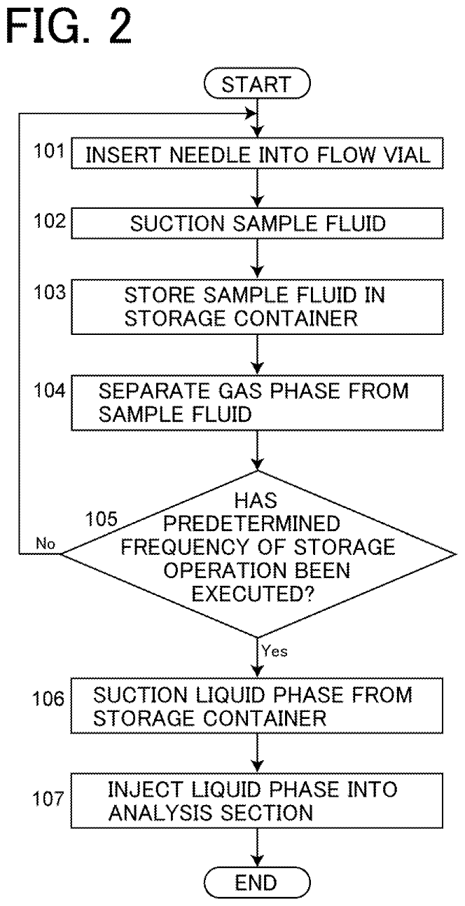

An example of a liquid sampling method in the flow monitoring system will be described with reference to the flowchart of FIG. 2.

When the time to execute sampling comes, the controller 42 inserts the distal end of the needle 22 into the flow vial 26 in a state where the syringe pump 24 is fluidly connected to the needle 22 (step 101), and causes the syringe pump 24 to suction, from the distal end of the needle 22, the sample fluid flowing through the flow vial 26 (step 102). Thereafter, the controller 42 pulls out the needle from the flow vial 26, moves the needle 22 to a position above the storage container 30 that is empty, and stores the suctioned sample fluid in the storage container 30 (step 103). After the sample fluid is stored in the storage container 30, the sample fluid is held in the storage container 30 for a certain period of time, whereby the gas phase is separated from the liquid phase of the sample fluid (step 104). The sample fluid suctioned from the flow vial 26 contains a gas phase and a liquid phase, and if the sample fluid is stored in the storage container 30 of an open top surface, the gas phase contained in the dispensed sample fluid escapes above the liquid phase, and only the liquid phase is stored in a bottom part of the storage container 30.

Steps 101 to 104 described above are one time of storage operation. The controller 42 causes the sampling section 12 to repeatedly execute the storage operation the flow path calculated in advance by the arithmetic section 46 or the flow path set in advance by the user (step 105), and stores, in the storage container 30, a liquid phase of a predetermined amount or more to be injected as a sample into the analysis section 14.

After causing the sampling section 12 to execute the storage operation a predetermined flow path (step 105: Yes), the controller 42 causes the distal end of the needle 22 to access the liquid phase stored in the storage container 30, and causes the syringe pump 24 to suction, from the storage container 30, a liquid phase of a predetermined amount to be injected into the analysis section 14 or greater than the predetermined amount (step 106). Thereafter, the controller 42 fluidly connects the distal end of the needle 22 to the injection port 28, and injects a predetermined amount of liquid phase as a sample into the mobile phase flowing through the analysis flow path 20 (step 107).

The above sampling is set to be automatically executed when a preset time comes. When a plurality of times of sampling are automatically executed, the plurality of empty storage containers 30 having been prepared can be used in sequence for each sampling. Note that the present invention is not limited to this, and includes an aspect in which one storage container 30 is washed and repeatedly used. In that case, in addition to the mechanism that supplies a cleaning liquid to the storage container 30, a mechanism that discharging the used liquid from the storage container 30 to a drain is provided.

In the above example, sampling of the sample fluid is performed using the flow vial 26, but the present invention is not limited to this, and includes performing sampling of the sample fluid without using the flow vial 26.

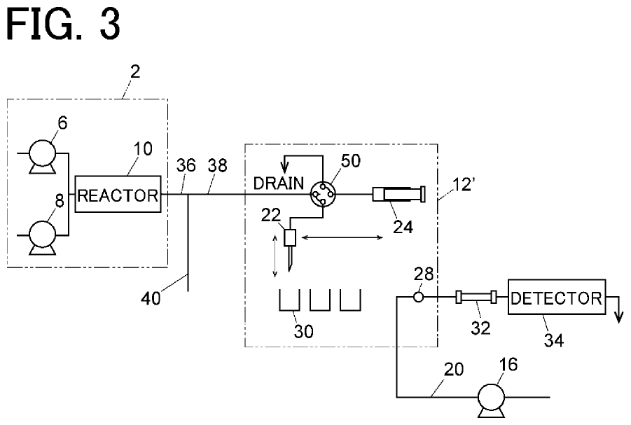

FIG. 3 shows an example of the configuration of a sampling section for executing a liquid sampling method without using a flow vial.

The sampling section 12 ‘shown in the example of FIG. 3 includes a multi-port valve 50, which is a flow path switching section. Each port of the multi-port valve 50 is fluidly connected with the needle 22, the syringe pump 24, the flow path 38 through which a sample fluid from the flow synthesis device 2 flows, and a flow path leading to the drain. The needle 22 is fluidly connected selectively to any one of the flow path 38 and the syringe pump 24 by the multi-port valve 50. At the time of sampling, the needle 22 is fluidly connected to the flow path 38 by the multi-port valve 50, the sample fluid supplied from the flow synthesis device 2 through the flow path 38 is dispensed into the storage container 30, and the liquid phase in the sample fluid is stored as a sample in the storage container 30. Thereafter, the multi-port valve 50 is switched so that the syringe pump 24 is fluidly connected to the needle 22, and the sample stored in the storage container 30 is suctioned through the needle 22 by the syringe pump 24 and injected into the mobile phase flowing through the analysis flow path 20 through the injection port 28.

The example described above is merely an example of an embodiment of a flow monitoring system according to the present invention. The embodiment of the flow monitoring system according to the present invention is as follows.

One embodiment of a liquid sampling method according to the present invention is a liquid sampling method in a flow monitoring system, wherein the flow monitoring system includes a sampling section having a needle for performing sampling of a liquid and a storage container, an analysis section that performs analysis of the liquid sampled by the sampling section, and a fluid supply section that supplies a sample fluid in a state of gas-liquid two-phase flow containing a gas phase and a liquid phase with the sample remaining in the state of gas-liquid two-phase flow,
the liquid sampling method including:
a storage step of collecting and storing, in the storage container, a predetermined amount of the sample fluid flowing through the liquid supply section;
a separation step of separating a gas phase contained in the sample fluid stored in the storage container from a liquid phase; and
an injection step of suctioning the liquid phase stored in the storage container from a distal end of the needle after the separation step and injecting a predetermined amount of the liquid phase as a sample into the analysis section through the injection port.

In an aspect [1] of the one embodiment,
the sampling section may further include
a syringe pump provided so as to be fluidly connected to the needle and for perform suctioning and dispensing of a fluid through the needle, and
a flow vial having an inlet for causing a fluid to flow into an internal space and an outlet for causing the fluid to flow out from the internal space, and configured to be accessible to the internal space by the needle, and
in the storage step, a liquid phase contained in the sample fluid may be stored in the storage container by executing, at least one time, a storage operation of causing the needle to access the internal space of the flow vial, suctioning the sample fluid flowing through the flow vial from a distal end of the needle by the syringe pump, and storing, from the distal end of the needle into the storage container, the sample fluid suctioned.

The aspect [1] may further include
a storage times calculation step of calculating a times of storage operation to be executed during the storage step in order to store, in the storage container, the liquid phase of the predetermined amount or more using a gas-liquid mixing rate and a capacity of the syringe pump, wherein the gas-liquid mixing rate is a ratio between the liquid phase and the gas phase contained in the fluid supplied to the internal space of the flow vial, wherein
in the storage step, the storage operation may be repeated for a flow path calculated in the storage times calculation step. Such aspect can reliably store, in the storage container, a liquid phase of an amount to be injected as a sample into the analysis section, and can improve reproducibility of analysis.

Here, as the gas-liquid mixing rate, input by the user may be received.

In an aspect [2] of one embodiment, the analysis section (14) includes
a separation column for separating, from each other, components contained in the sample injected through the injection port, and
a detector for detecting each of the components separated from each other by the separation column.

In an aspect [3] of one embodiment, the sampling section may further include
a syringe pump provided so as to be fluidly connected to the needle and for perform suctioning and dispensing of a fluid through the needle, and
a flow path switching section, and
in the storage step, the needle may be caused to be in fluid communication with the fluid supply section via the flow path switching section, and a liquid phase contained in the sample fluid may be stored in the storage container as a sample.

In the above aspect [3], the flow path switching section may be configured to selectively connect the needle to either the sample supply section or the syringe pump,
the flow path switching section may fluidly connect the needle and the fluid supply section in the storage step, and
the flow path switching section may fluidly connect the needle and the syringe pump in the injection step.

### DESCRIPTION OF REFERENCE SIGNS

1 flow monitoring system
2 flow synthesis device (fluid supply section)
4 analysis device
6, 8, 16 pump
10 reactor
12 sampling section
14 analysis section
18 control device
20 analysis flow path
22 needle
24 syringe pump
26 flow vial
28 injection port
30 storage container
32 separation column
34 detector
42 controller
44 information storage section
46 arithmetic section

What is claimed is:

1. A liquid sampling method in a flow monitoring system, wherein
the flow monitoring system includes a sampling section having a needle for performing sampling of a liquid and a storage container,
an analysis section that performs analysis of the liquid sampled by the sampling section, and
a fluid supply section that supplies a sample fluid in a state of gas-liquid two-phase flow containing a gas phase and a liquid phase with the sample remaining in the state of gas-liquid two-phase flow,
the liquid sampling method comprises:
a storage step of collecting a predetermined amount of the sample fluid flowing through the liquid supply section and storing the collected sample fluid in the storage container;
a separation step of separating a gas phase contained in the sample fluid stored in the storage container from a liquid phase; and
an injection step of suctioning the liquid phase stored in the storage container from a distal end of the needle after the separation step and injecting a predetermined amount of the liquid phase as a sample into the analysis section through the injection port.

2. The liquid sampling method according to claim 1, wherein the sample fluid is left to stand for a predetermined time in the storage container in the separation step.

3. The liquid sampling method according to claim 1, wherein
the sampling section further includes
a syringe pump provided so as to be fluidly connected to the needle and for perform suctioning and dispensing of a fluid through the needle,
a flow vial having an inlet for causing a fluid to flow into an internal space and an outlet for causing the fluid to flow out from the internal space, and configured to be accessible to the internal space by the needle,
an injection port configured to be able to fluidly connect the distal end of the needle and for injecting a sample from the needle into the analysis section, and
a storage container that is a container of an open top surface to which the needle is accessible from above, the storage container for storing a liquid phase contained in a fluid dispensed from the distal end of the needle, and
in the storage step, a liquid phase contained in the sample fluid is stored as a sample in the storage container by executing, at least one time, a storage operation of causing the needle to access the internal space of the flow vial, suctioning the sample fluid flowing through the flow vial from a distal end of the needle by the syringe pump, and dispensing, from the distal end of the needle into the storage container, the sample fluid suctioned.

4. The liquid sampling method according to claim 3, further comprising a storage times calculation step of calculating times of storage operation to be executed during the storage step in order to store, in the storage container, the sample of the predetermined amount or more based on a gas-liquid mixing rate and a capacity of the syringe pump, wherein the gas-liquid mixing rate is a ratio between the liquid phase and the gas phase contained in the sample fluid supplied to the internal space of the flow vial,
wherein in the storage step, the storage operation is repeated for a flow path calculated in the storage times calculation step.

5. The liquid sampling method according to claim 1, wherein
the analysis section includes
a separation column for separating, from each other, components contained in the sample injected through the injection port, and
a detector for detecting each of the components separated from each other by the separation column.

6. The liquid sampling method according to claim 1, wherein
the sampling section further includes
a syringe pump provided so as to be fluidly connected to the needle and for perform suctioning and dispensing of a fluid through the needle, and
a flow path switching section, and
in the storage step, the needle is caused to be in fluid communication with the fluid supply section via the flow path switching section, and a liquid phase contained in the sample fluid is stored in the storage container as a sample.

7. The liquid sampling method according to claim 6, wherein
the flow path switching section is configured to selectively connect the needle to either the sample supply section or the syringe pump,
the flow path switching section fluidly connects the needle and the fluid supply section in the storage step, and
the flow path switching section fluidly connects the needle and the syringe pump in the injection step.
